(19) United States
(12) Patent Application Publication
(10) Pub. No.: US 2015/0131124 A1
(43) Pub. Date: May 14, 2015

(54) PRINTING A DOCUMENT FROM DIFFERENT GEOGRAPHICAL LOCATIONS ON WORLD WIDE WEB

(71) Applicant: ARC Document Solutions, Inc., Walnut Creek, CA (US)

(72) Inventors: Rahul ROY, Fremont, CA (US); Srinivasa Rao MUKKAMALA, Kolkata (IN); Srikant SHARAMA, Kolkata (IN)

(73) Assignee: ARC Document Solutions, Inc., Walnut Creek, CA (US)

(21) Appl. No.: 14/540,747

(22) Filed: Nov. 13, 2014

Related U.S. Application Data
(60) Provisional application No. 61/903,881, filed on Nov. 13, 2013.

(51) Int. Cl. G06F 3/12; G06K 15/02

(52) U.S. Cl. CPC G06F 3/1287; G06F 3/1206; G06F 3/1236; G06F 3/1288; G06F 3/1292; G06K 15/1806; G06K 15/1815
USPC 358/1.15

(57) ABSTRACT

System and method for printing a document from different geographical locations on World Wide Web are disclosed. For printing the document, a print request comprising a plurality of data fields and data values is received. The plurality of data fields comprises at least one of document details, print characteristics, a location, and a print schedule. Based on the location received in the print request, at least one print client is identified. After identifying the print client, the print request is transmitted to the print client using a managed file transfer protocol for catering to the print request.

### REFERENCE TO RELATED APPLICATIONS

The application claims benefit of priority to U.S. Provisional Patent Application No. 61/903,881, filed with the United States Patent and Trademark Office on Nov. 13, 2013, entitled “A SYSTEM AND METHOD FOR PROVIDING CONTENT CREATION, COLLABORATION, MANAGEMENT, AND DELIVERY OF ELECTRONIC DOCUMENTS,” the entirety of which is hereby incorporated by reference.

### FIELD OF INVENTION

The present disclosure in general relates to a printing of a document over World Wide Web. More particularly, the present disclosure relates to a system(s) and method(s) for printing a document from different geographical locations on World Wide Web.

### BACKGROUND

Enterprises require collaborative content creation and transfer of documents from one location to another. Often, the documents may be large and complex. With the explosion in use of rich content, the documents have evolved into diverse document file types such as audio, video, graphics and other documents such as Microsoft PowerPoint™, Microsoft Word™ and Microsoft Excel™ or Microsoft Spreadsheet™ documents. The document file types may allow embedding graphics in the documents and increase size of the document.

Generally, in order to send the documents from one location to another, the documents may be attached to an email and sent to recipients. To send the documents, email servers may configure and transfer the emails from sender to recipient. Sending the documents comprising embedded graphics using the email servers has several problems. Generally, the email servers are configured to prohibit sending the documents which have a size of 10 Megabytes and more. The email servers may be configured to restrict sending the large size documents to avoid spam and/or to reduce load on the email server. Further, when the documents are sent through the email servers, the embedded graphics in the documents may change making the documents unreadable or difficult to understand, specifically if the document comprises a design/drawing. Based on storage capability of original email design, storing of many documents that are larger in size may not be feasible and may burden existing email storage capability.

The enterprises may choose to send the documents in other means to print at another location e.g. through network connected printers. The enterprises may send the documents to the printer that is connected over internet. After sending the documents, the enterprise may print the documents. After printing the documents locally, the printed documents may be shipped through mail services, such as FedEx. Use of mail services to transfer the documents after printing are time consuming and costlier.

With the emergence of cloud print, some or all activities for printing the documents may be handled by a remote network of computers and servers. The printers may be connected to internet and the documents may be processed in a cloud computing environment. After processing, the documents may then be printed at a desired location.

### SUMMARY

This summary is provided to introduce concepts related to systems and methods for printing a document from different geographical locations on World Wide Web and the concepts are further described below in the detailed description. This summary is not intended to identify essential features of the claimed subject matter nor is it intended for use in determining or limiting the scope of the claimed subject matter.

In one implementation, a method for printing a document from different geographical locations on World Wide Web is disclosed. The method comprises receiving a print request, at a server. The print request comprises a plurality of data fields and data values. The plurality of data fields comprises at least one of document details, print characteristics, a location, and a print schedule. The method further comprises identifying at least one print client based on the location received in the print request. The method further transmitting the print request to the identified print client using a managed file transfer protocol for catering to the print request.

In one implementation, a system for printing a document from different geographical locations on World Wide Web is disclosed. The system comprises a processor and a memory coupled to the processor. The processor is capable of executing program instructions stored in the memory. The processor executes the program instructions to receive a print request comprising a plurality of data fields and data values. The plurality of data fields comprises at least one of document details, print characteristics, a location, and a print schedule. The processor further executes the program instructions to identify at least one print client based on the location received in the print request. The processor further executes the program instructions to transmit the print request to the identified print client using a managed file transfer protocol for catering to the print request.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system printing a document from different geographical locations on World Wide Web, in accordance with an embodiment of the present disclosure.

FIG. 2 illustrates the system, in accordance with an embodiment of the present disclosure.

FIG. 3 illustrates a method for printing a document from different geographical locations on World Wide Web, in accordance with an embodiment of the present disclosure.

### DETAILED DESCRIPTION

System(s) and method(s) for printing a document from different geographical locations on World Wide Web are disclosed. In order to print the document from different geographical location, at first, a print request may be received at a server. The print request may comprise a plurality of data fields and data values associated with the data fields. The plurality of data fields may comprise at least one of document details, print characteristics, a location, and a print schedule. For each of the data field, the data values may be received. The print characteristics may comprise number of copies to be printed, size of the document, and orientation of the document.

After receiving the print request, based on the data values received for the location in the print request, at least one print client may be identified. The at least one print client may be selected from a list of print clients that may be pre-defined. Each print client may be configured to support implementation of a cloud print service. The print client may be a cloud-aware printer.

After identifying the at least one print client, the print request may be transmitted to the print client. The print client may be transmitted using a managed file transfer protocol for catering to the print request. The print request may be transmitted to the print client based on the location received in the data values. In case the print client is not available at the location received in the print request, the print request may be transmitted to the print client that may be near to the location received. After the print request is transmitted to the print client, the documents may be printed based on the print characteristics and the print schedule. Subsequent to printing the documents based on the print request, the documents may be delivered to the location using conventional mail services.

While aspects of described system and method for printing a document from different geographical locations on World Wide Web may be implemented in any number of different computing systems, environments, and/or configurations, the embodiments are described in the context of the following exemplary system.

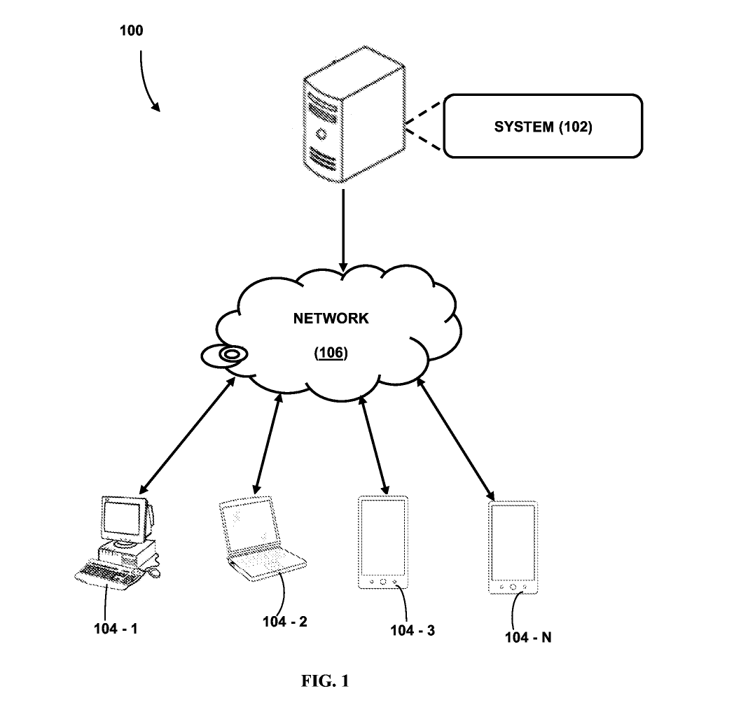

Referring now to FIG. 1, a network implementation 100 of a system 102 for printing a document from different geographical locations on World Wide Web is illustrated, in accordance with an embodiment of the present disclosure. The system 102 may receive a print request comprising a plurality of data fields and data values. The plurality of data fields comprises at least one of document details, print characteristics, a location, and a print schedule.

Subsequent to receiving the print request, the system 102 may identify at least one print client based on the location. After identifying the at least one client, the system 102 may transmit the print request to the identified print client using a managed file transfer protocol. Although the present disclosure is explained by considering a scenario that the system 102 is implemented as an application on a server. It may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

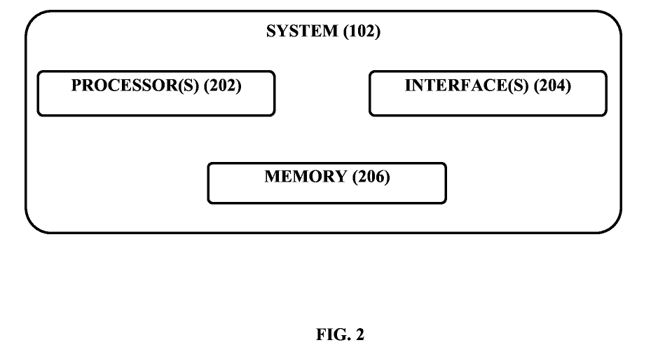

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, an Application Program Interface (API) and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, at first, a user may use the client device 104 to access the system 102 via the I/O interface 204. The working of the system 102 may be explained in detail using FIG. 2 explained below. The system 102 may be used for printing a document from different geographical locations on World Wide Web. At first, the system 102 may receive a print request. In one implementation, the system 102 may receive the print request via the I/O interface 204. In order to provide the print request as an input, the user may have to register him/her with the system 102. After the user is registered with the system 102, the user may be provided with security credentials to access the system 102. Subsequently, when the user tries to access the system 102, the security credentials of the user with respect to the registration may be checked. After the credentials of the user are checked, the system 102 may present an application to the user. The application may comprise a plurality of data fields. The system 102 may receive the print request from the plurality of data fields. The data fields may comprise data values associated with the data fields.

In one example, the data fields may comprise at least one of document details, print characteristics of the document, a location, and a print schedule. Each data field may comprise data values to receive details corresponding to the data field. In one example, the least one of document details may comprise name of the document. In one example, the least one of document details may comprise one or more documents that may be uploaded to the system 102. In one example, the documents may comprise a word document, a spreadsheet document, an image file, a pdf file. The documents may comprise other files that contain information in a certain format and use of such files is obvious to persons skilled in the art. In one example, the system 102 may receive a user created content such as text, an image in the data field. In another example, the system 102 may receive the document from an email application. The system 102 may receive document from the email application as an attachment. In one example, the system 102 may receive the document using a plug-in of the email application.

After receiving the document in the data field, the system 102 may receive the data value for the print characteristics. The print characteristics may indicate parameters that have to be taken care while sending the documents to another location for printing. In one example, the system 102 may receive the data value such as number of copies to be printed as the print characteristics. In another example, the print characteristics may comprise colors and text contour to be used for the documents. In another example, if the document contains a drawing, the system 102 may receive the data value as maintain the contours of the edges, line thickness, and colors etc.

Further, the print request may comprise the data field for specifying the location where the document should be sent and printed. To send the print request from one location to another, the user may have to identify/specify the location where the documents have to be printed and delivered. For example, the system 102 may receive the data value as Newyork indicating that the document should be sent to Newyork for printing. Further, the system 102 may receive the data value for the data field i.e., the print schedule. The print schedule may indicate a time at which the document may have to be printed. In one example, the system 102 may receive date and time of a particular day. In one example, the system 102 may receive the data value as Nov. 30, 2014 in the data field of the print schedule.

In one implementation, the system 102 may allow one or more users to share the print request. By allowing the one or more users to share the print request, the one or more users may upload/add the documents in the data field of the document details. In one implementation, the system 102 may allow the one or more users to modify or replace the documents that are uploaded to the system 102. In one example, the system 102 may allow a user to upload and transfer the documents to other users. The user may set preferences such that other users may modify or replace the documents. In one example, the system 102 may allow permission to a company-wide, a team to modify the documents. In one implementation, the system 102 may allow permissions to the one or more users to modify the print characteristics. After receiving the modifications in the documents, the system 102 may provide an option to the one or more users to revert to any of the modifications made to the documents. For example, consider a document is modified four times by the one or more users. If any of the users would like to revert to a second modification, the system 102 may allow the user to access the second modification of the document.

In one implementation, the system 102 may allow the one or more users to share the documents using a dropbox feature. The dropbox feature may be used to share a folder comprising two or more documents with the one or more users. In one example, the system 102 may allow the one or more users to add the documents in the folder using the dropbox feature. In one implementation, the system 102 may receive the document details from the dropbox feature. In one implementation, the system 102 may allow the one or more users to download the documents from the dropbox feature. The system 102 may track a history of the download by the one or more users.

In one implementation, the system 102 may provide a status of the print request. The status may indicate receiving the document details of the print request. In one example, the status may be provided to show receiving the data values corresponding to each of the data fields. In one example, the system 102 may provide the status in real time. In one example, the system 102 may provide the status statically. In one example, the user may preset the time at which he/she intend to receive the status of the print request. For example, the user may preset a time interval of 24 hours to receive the status. Based on the time set, the system 102 may provide the status for every 24 hours. In one implementation, the system 102 may allow the one or more users to modify the data values in the data fields. In one example, the one or more users may modify the number of copies specified in the data field. In another example, one or more users may modify the print characteristics of the document. Similarly, the one or more users may modify the print schedule in the print request.

In one implementation, based on the print request, the system 102 may generate a fee quote. The fee quote may indicate an amount the user may have to pay for sending the print request to another location. In one example, the fee quote may be generated based on the print characteristics specified by the user. For example, the fee quote may be generated based on the number of copies specified in the data field of print characteristics. In one implementation, the system 102 may verify the print request. In one example, the system 102 may verify the print characteristics and number of copies received in the print request. After verifying the print request, the system 102 may send a confirmation message to the user.

After receiving the print request, the system 102 may identify at least one print client to send the print request. In one implementation, the system 102 may identify the at least one print client based on the location received in the print request. In one example, the system 102 may identify the at least one print client from a pre-defined list. The system 102 may present the pre-defined list comprising a plurality of print clients. After the list is presented, the user may select the at least one print client for sending the print request. In one implementation, if the user specified location does not have the at least one print client, the system 102 may identify the at least one print client that may be available nearest to the location received.

After identifying the at least one print client, the system 102 may transmit the print request to the at least one print client. The system 102 may transmit the print request using a managed file transfer protocol for catering to the print request. The system 102 may transmit the print request to the print client based on the location received in the data values. Each print client may be associated with a print service provider. The print service provider may indicate a service provider providing on-demand printing of digital data such as the documents. The print service provider may print the digital data from mobile applications and websites through a network of global printing facilities. In one implementation, the print client may be a cloud-aware printer. In another implementation, the print client may be coupled to the cloud-aware printer. In one example, the print client may be a computer. In another example, the print client may be an application installed on the computer. In one implementation, the system 102 may send the print request through a cloud computing environment so that the documents may be printed at a facility of the print service provider.

In one example, the print request may be transmitted to the cloud-aware printer that may be connected to internet. As discussed, the print request may be transmitted using the managed file transfer. The managed file transfer may be used to transfer the print request securely from the user device 104 to the print client. In other words, the managed file transfer may be used to provide communication between the user device 104 and the print client using a secure connection. In one example, a secure sockets layer (SSL) connection may be used to provide communication between the user device 104 and the print client. The managed file transfer enables the print service provider to securely access, manage and control the documents via the internet. Further, the managed file transfer enables the print service provider to monitor, control flow of information of file transfers from the user devices 104 to the print service providers.

In one implementation, the managed file transfer is used to transfer the documents of larger size e.g., 15 Megabytes file. Further, the managed file transfer is used to transfer the documents comprising high quality images e.g., image having multimillion pixels. In one example, the documents such as audio and video files comprising high definition content may be transferred securely using the managed file transfer.

As discussed, the print client may be identified based on the location received. For example, if the location received in print request is Newyork, the system 102 may transmit the print request to Newyork. In case the print client is not available at the location received in the print request, the system 102 may transmit the print request to a location near to the location specified by the user.

After the print request is transmitted to the print client, the print service provider may print the documents based on the print characteristics and the print schedule received. In one implementation, the system 102 may receive a status of the cloud-aware printer. In one example, the system 102 may receive the status of the cloud-aware printer e.g., the cloud-aware printer is active. In case the cloud-aware printer does not provide the status, the system 102 may transmit the print request to another print client. As discussed, the print service provider may have the print client to receive the print request. After the print request is transmitted, the print client may instruct the cloud-aware printer to print the documents. The print client may instruct the cloud-aware printer to print the documents based on the print characteristics and the print schedule in the print request. In one implementation, if the transmission of the print request fails, the system 102 may re-transmit the print request until the print request is sent to the desired print client.

When the print client is installed on the cloud-aware printer, the print request may be transmitted directly to the cloud-aware printer. Based on the print request, the cloud-aware printer may print the documents. Subsequent to printing the documents based on the print request, the documents may be delivered to a location received in the print request.

The system 102 uses the managed file transfer protocol to transfer the documents that are larger in size, quality and involving complex documents. By using the managed file transfer protocol, the system 102 transfers the documents securely across world. In one implementation, the managed file transfer facilitates in generating reports based on the print request. The reports generated may show a list of the documents that are accessed across various locations. Further, the managed file transfer protocol provides a status of the documents that are received at the print client. Further, the managed file transfer protocol provides the reports such as notifications indicating a success or a failure of the transmission of the print request. The system 102 uses the managed file transfer protocol to provide security, consistent file organization and control to transmit the print request as compared to a File Transfer Protocol (FTP).

In one implementation, the system 102 may integrate with Microsoft Outlook™ to allow the one or more users to send and manage larger files or attachments. In one implementation, the cloud print service may store the documents in the cloud environment (remote servers) for retrieval and easy access of the documents from any geographical locations.

In one implementation, the system 102 may be implemented in a distributed computing architecture such as Content Delivery Networks (CDN) for delivering large documents. The CDN facilitates in timely delivery of the documents by allowing availability of the documents at various locations. Allowing the documents to be available at various locations allows the CDNs to store and retrieve the documents at a location closer to the location received in the print request. Retrieving the documents closer to the location received in the print request may reduce latency and increase throughput.

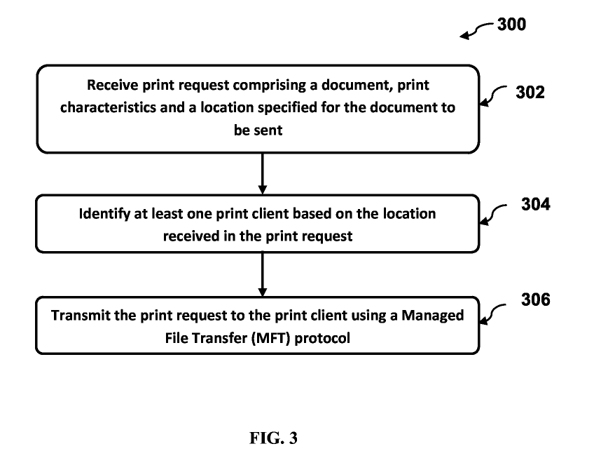

Referring now to FIG. 3, a method 300 for printing a document from different geographical locations on World Wide Web is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described and is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method may be implemented in any suitable hardware, software, firmware, or combination thereof. However, for ease of explanation, in the embodiments described below, the method 300 may be implemented in the above-described system 102.

At step/block 302, a print request may be received at a server. The print request may comprise a plurality of data fields and data values. The plurality of data fields comprises at least one of document details, print characteristics, a location, and a print schedule.

At step/block 304, at least one print client may be identified. The at least one print client may be identified based on the location received in the print request.

At step/block 306, the print request may be transmitted to the identified print client using a managed file transfer protocol for catering to the print request. After the print request is transmitted, the documents received in the print request may be printed. The documents may be printed based on the print characteristics and print schedule received in the print request.

The system 102 may be implemented using green technology. The system 102 may be implemented by the cloud print service providers that may be recognized with Green Certification. By sending the documents from different geographical locations on World Wide Web, the system 102 reduces consumption of resource-intensive goods. By sending the documents from different geographical locations on World Wide Web, the print service providers may be ensured in employing environmental friendly approaches for printing the document and management of repro graphic practices.

The system 102 implementation facilitates in reduction of carbon footprint. The print service provider may be ensured to print the documents on recycled media. The documents printed using recycled media may result in reclaiming of tons of paper every year. By sending the documents from different geographical locations on World Wide Web, fuel cost may be saved.

Although implementations for methods and providing printing a document from different geographical locations on World Wide Web have been described in language specific to structural features and/or methods, it is to be understood that the appended claims are not necessarily limited to the specific features or methods described. Rather, the specific features and methods are disclosed as examples of implementations for printing a document from different geographical locations on World Wide Web.

1. A method for printing a document from different geographical locations on world wide web, the method comprising:
receiving a print request, at a server, wherein the print request comprises a plurality of data fields and data values, wherein the plurality of data fields comprises at least one of document details, print characteristics, a location, and a print schedule;
identifying at least one print client based on the location received in the print request; and
transmitting the print request to the identified print client using a managed file transfer protocol for catering to the print request.

2. The method of claim 1, wherein the print client is a cloud-aware printer.

3. The method of claim 1, wherein the print client is coupled to a cloud-aware printer, wherein the print client is a computer.

4. The method of claim 3, further comprising receiving a status of the cloud-aware printer from the print client.

5. The method of claim 1, further comprising re-transmitting the print request in case of failure in the transmission.

6. A system for printing a document from different geographical locations on world wide web, the system comprising:
a processor; and
a memory coupled to the processor, wherein the processor is capable of executing program instructions stored in the memory, to:
receive a print request comprising a plurality of data fields and data values, wherein the plurality of data fields comprises at least one of document details, print characteristics, a location, and a print schedule;
identify at least one print client based on the location received in the print request; and
transmit the print request to the identified print client using a managed file transfer protocol for catering to the print request.

7. The system of claim 6, wherein the print client is a cloud-aware printer.

8. The system of claim 7, wherein the print client is coupled to a cloud-aware printer, wherein the print client is a computer.

9. The system of claim 8, wherein the processor further executes the program instructions to receive a status of the cloud-aware printer from the print client.

10. The system of claim 9, wherein the processor further executes the program instructions to re-transmit the print request in case of failure in the transmission.

11. A non-transitory computer readable medium embodying a program executable in a computing device for printing a document from different geographical locations on world wide web, the program comprising:
a program code for receiving a print request comprising a plurality of data fields and data values, wherein the plurality of data fields comprises at least one of document details, print characteristics, a location, and a print schedule;
a program code for identifying at least one print client based on the location received in the print request; and
a program code for transmitting the print request to the identified print client using a managed file transfer protocol for catering to the print request.
